(19) United States
(12) Patent Application Publication
(10) Pub. No.: US 2006/0240699 A1
(43) Pub. Date: Oct. 26, 2006

(54) Ball grid array connector guidance, alignment, and strain relief

(75) Inventor: Donald K. Harper JR., Camp Hill, PA (US)

Correspondence Address: WOODCOCK WASHBURN, LLP, ONE LIBERTY PLACE - 46TH FLOOR, PHILADELPHIA, PA, 19103, US

(73) Assignee: FCI Americas Technology, Inc., Reno, NV (US)

(21) Appl. No.: 11/112,235

(22) Filed: Apr. 21, 2005

(51) Int. Cl. H01R 13/64

(52) U.S. Cl. 439/378

(57) ABSTRACT

A strain relief device that includes a substrate component for mounting to a substrate prior to assembly of the strain relief device is disclosed. The substrate component is mounted on a substrate and a connector component that is attached to an electrical connector is press-fit or otherwise attached to the substrate component. The substrate component includes alignment elements, such as protrusions, that complement alignment elements, such as indentations, on the connector component. The alignment elements provide protection to the electrical connector against sheer forces as well as forces caused by CTE mismatches. The strain relief device may include an alignment pin received in an indentation formed in the connector component that extends such that, as the substrate component is mated with the connector component, the pin performs an alignment function as the pin is received in a corresponding indentation of the substrate component.

### FIELD OF THE INVENTION

The invention relates generally to electrical connectors. More specifically, the invention relates to relieving strain on electrical connectors connected to substrates.

### BACKGROUND OF THE INVENTION

Surface mounted electrical connectors may include strain relief devices. Strain relief devices may take the form of connector posts that extend into a surface of a mounting substrate. However, creating post receiving through-holes in a PCB is not acceptable in some applications because of extra manufacturing steps and reduction of usable board space. Additionally, in some devices, posts extend through the substrate and a nut or other fastener is used to hold the connector in place on the substrate. Such a strain relief device requires expensive manual assembly (e.g., manually turning a nut onto a post). Other connectors include a strain relief device that is mounted on the surface of a substrate. The strain relief device is attached or molded as part of an electrical connector and is attached to the substrate at the time that the connector is electrically connected to the substrate.

Strain relief devices are used, in part, to compensate for coefficient of thermal expansion (CTE) mismatches, which in turn may cause electrical connectivity breaks where connector contacts are connected to a substrate surface. Surface mounted connectors, however, may also be subjected to shear forces caused by orthogonally mated boards, such as a vertical motherboard connector connected to an orthogonally mated daughter card. These shear forces, which may be a function of the mass of the orthogonally mated daughter card, the length of the card with respect to the connection, and gravity, can impart a significant strain on electrical connectors that are surface mounted to the motherboard. Additionally, connectors may also experience compression forces caused by, for example, vertical daughter cards mounted and pressing down on a horizontal motherboard. While strain relief devices may prove effective to minimize CTE mismatches, they may not be effective in minimizing sheer forces on electrical connectors. Therefore, there is a need for strain relief devices for electrical connectors that minimize CTE mismatches and carry shear and compressive forces.

### SUMMARY OF THE INVENTION

The invention includes a strain relief device that minimizes CTE mismatches and carries shear and compressive forces. The strain relief device according to the invention includes a substrate component and a connector component. The substrate component is mounted on a substrate such as a motherboard either by surface mounting or using through-hole techniques. The connector component is attached to or formed as part of an electrical connector. The substrate component includes alignment elements, such as protrusions, that are of a shape complementary to alignment elements, such as indentations, on the connector component. When the electrical connector is connected to the substrate, the connector component alignment element is mated with the alignment element of the substrate component that was previously mounted on the substrate. The alignment elements may be press-fit together and provide protection to the electrical connector against sheer forces as well as forces caused by CTE mismatches.

In an alternative embodiment, the strain relief device includes an alignment pin. The alignment pin may be received in an indentation formed in, for example, the substrate component, and may extend such that, as the connector component is mated with the substrate component, the pin performs an alignment function as the pin is received in a corresponding indentation of the connector component, facilitating the alignment of the two components as the mating process is initiated and completed.

In another alternative embodiment, the substrate component may be mounted on the substrate such that the strain relief device is able to carry a compressive load, that is, a load placed on the strain relief device in a direction towards the substrate. Pins that are used to mount the substrate component on the substrate include shoulders that abut the substrate to carry such a compressive load.

### BRIEF DESCRIPTION OF THE DRAWINGS

FIGS. 1A, 1B, and 1C depict an example strain relief device according to the invention.

FIG. 2 depicts an example substrate face of a substrate component of a strain relief device disposed for mounting on a surface of a substrate.

FIG. 3 is a cross-section of an example pocket and post shown on the example substrate component of FIG. 2.

FIG. 4 depicts an example substrate face a substrate component of a strain relief device disposed for attaching to a substrate using holes formed in the substrate.

FIG. 5 is a cross section of an example post shown on the example substrate component of FIG. 4.

### DETAILED DESCRIPTION OF ILLUSTRATIVE EMBODIMENTS

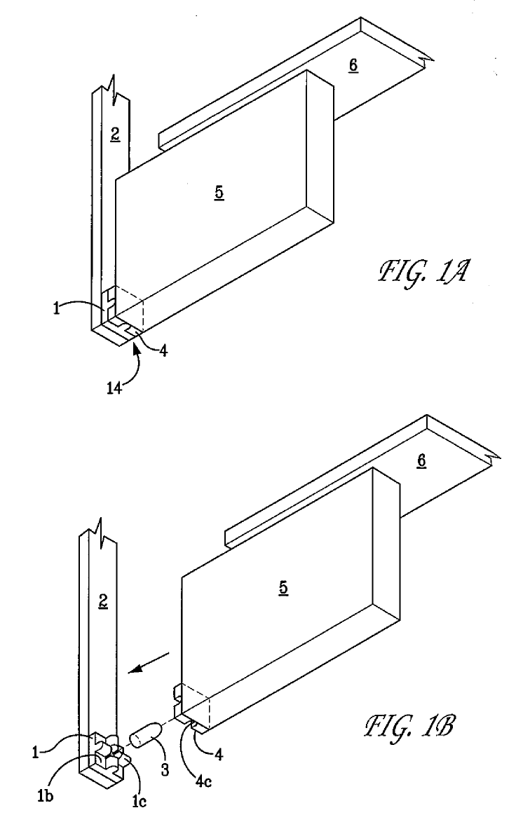

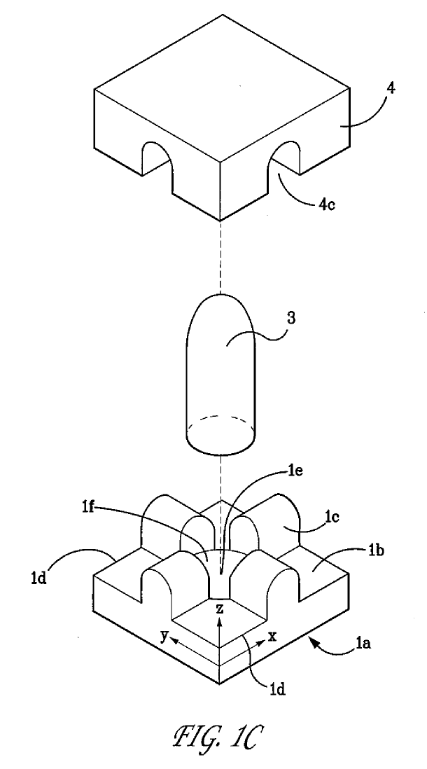

FIGS. 1A, 1B, and 1C depict an example strain relief device 14 according to the invention. FIG. 1A shows the example strain relief device 14 assembled, and FIGS. 1B and 1C each show an exploded view of the strain relief device 14. The strain relief device 14 includes a substrate component 1 and a connector component 4. The substrate component 1 is mounted on a substrate 2, which may be, for example, a motherboard, and the connector component 4 is mounted on or formed as part of an electrical connector 5. The electrical connector 5 may be used to electrically connect a substrate 6, which may be, for example, a daughter card, to the substrate 2.

The substrate component 1 is mounted on or attached to the substrate 2. The connector component 4 is mated to the substrate component 1 when the connector 5 is electrically connected to the substrate 2. When the connector 5 is brought to the motherboard 2, the connector component 4 is mated with the substrate component 1, thus forming the assembled strain relief device 14.

The substrate component 1 includes a substrate face 1a and a connector face 1b. The substrate face 1a abuts the motherboard 2 when the substrate component 1 is mounted on the motherboard 2. The connector face 1b faces the electrical connector 5 and abuts the connector component 4 when the electrical connector 5 is attached to the motherboard 2. The connector face 1b of the substrate component 1 includes one or more alignment elements 1c. The alignment element 1c may be a protrusion or elevated portion, protruding in a direction indicated by arrow Z shown in FIG. 1C, away from a plane defined by the connector face 1b. The alignment elements 1c may include protrusions that, for example, extend from an edge 1d of the substrate face 1b towards a center 1e of the substrate face 1b. Complementary alignment elements 4c are formed in the connector component 4 of the strain relief device 14. The alignment elements 4c may be of a shape complementary to the alignment elements 1c. In the example strain relief device 14, the alignment elements 4c include indentations to receive the alignment elements 1c when the strain relief device 14 is assembled. The alignment elements 1c, 4c are shaped and sized for a tight fit when the strain relief device 14 is assembled. This tight fit facilitates absorption of or resistance to sheer force placed on the electrical connector 5, as well as forces caused by CTE mismatches. Thus, when assembling the strain relief device 14, the substrate and connector components 1, 4 are press fit together, and the alignment elements 1c, 4c help prevent movement of the connector 5 and the connector component 4 relative to the substrate component 1.

It is understood that the alignment elements 1c may include indentations as well as, or in lieu of, protrusions and that the alignment elements 4c may include protrusions complementary to indentations in the alignment elements 1c. That is, FIGS. 1A-1C depict one embodiment of the invention, and the alignment elements 1c, 4c may be in other shapes such that, when mated, the strain relief device 14 at least in part absorbs forces placed on the electrical connector 5.

The substrate and connector components 1, 4 may be made of plastic or other non-conductive material. The connector component 4 may be of the same material as a housing (not shown) of the electrical connector 5 and may be formed as part of the electrical connector 5 or as part of a housing of the electrical connector 5. Additionally, the substrate and connector components 1, 4 may include a conductive capability. That is, the substrate component 1 may be made of a non-conductive material such as plastic and may include a metal strip extending from the connector face 1b through to the substrate face 1a. Likewise, the connector component 4 may be of a non-conductive material but may include a conductive strip extending from the connector 5 such that, when the connector component 4 is mated with the substrate component 1, the respective strips of the substrate and connector components 1, 4 may electrically connect, providing a mechanism for the discharge of static electric charge that may be created during the mating. Alternatively, the strain relief device 14 may be of a metallic or conductive material.

As shown in FIGS. 1A-1C, the substrate component 1 may include an indentation 1f in the connector surface 1b for receiving an alignment pin 3. The indentation 1f and the alignment pin 3 may be of complementary sizes to allow for a tight, press-fit of the alignment pin 3 in the indentation 1f. The connector component 4 may likewise include a corresponding indentation for receiving the alignment pin 3. Alternatively, the alignment pin 3 may be formed as a protrusion extending from either the substrate or connector component 1, 4. The alignment pin 3 may extend in the z direction (FIG. 1C) further than the alignment elements 1c, for example, and perform an alignment function, facilitating proper alignment of the substrate and connector components 1, 4 during mating. The alignment pin 3 additionally may add strength to the strain relief device 14, thus further absorbing or reducing effects of sheer forces and forces caused by CTE mismatches on the electrical connector 5 when mated to the substrate 2. The alignment pin 3 may be of an electrically conductive material such as zinc and may facilitate discharge of static electricity during mating by electrically connecting with conductive strips within the substrate and connector components 1, 4.

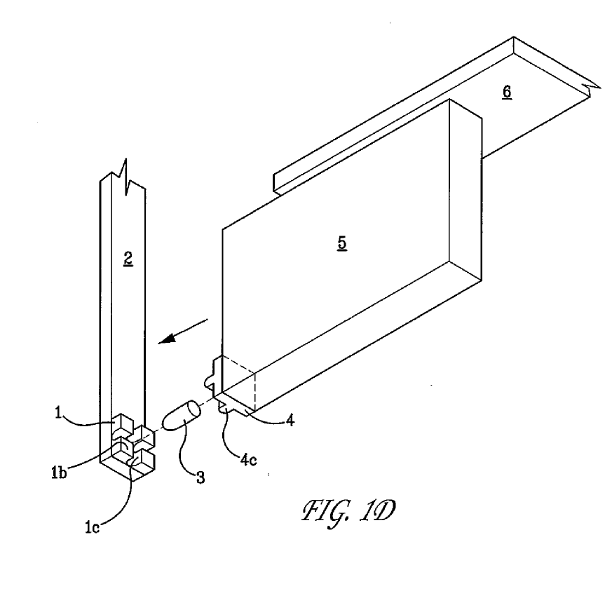

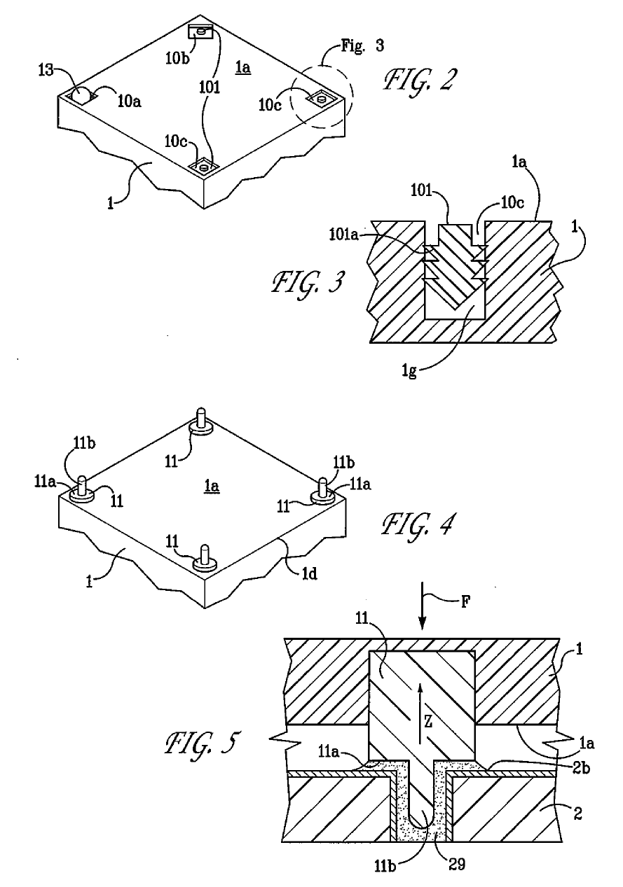

FIG. 2 depicts an example substrate face 1a of the substrate component 1 of a strain relief device 14 disposed for mounting on a surface of the substrate 2, according to the invention. FIG. 3 is a cross-section of an example pocket 10c and a post 101 shown on the example substrate face 1a of FIG. 2, according to the invention. FIG. 2 shows an example substrate side 1a of the substrate component 1 and includes a solder ball 13 and pockets 10a, 10b. The solder ball 13 may be attached to a post 101 of a pocket 10a. The solder ball 13 may thus be soldered to a corresponding pocket 10a and, when the substrate component 1 is to be mounted on the substrate 2, the solder ball 13 may be placed on a respective pad of the substrate 2. The solder ball 13 may then be reflowed, thus mounting the substrate component 1 to the substrate 2. The pockets 10a and 10b may be rectangular and are for receiving solder balls similar to solder ball 13. As shown by the pocket 10b, pockets may be placed at a non-0 degree angle to the edges 1d of the substrate component 1. Placing pockets on an angle may provide greater protection against sheer forces being placed at various angles to the connector 5 when connected to the substrate 2.

The pockets 10a, 10b may include the posts 101 on which a solder ball such as the solder ball 13 may be soldered. A post 101 may best be seen in FIG. 3. The post 101 may be inserted in an indentation 1g in the substrate side 1a of the substrate component 1. The post 101 may include ribs or barbs 101a that enable the post 101 to be press-fit into the indentation 1g and that cut into the plastic of the substrate component 1 such that the post 101 is substantially prevented from movement either further into or out of the indentation 1g. In this way, a solder ball such as the solder ball 13 may be pressed onto the post 101, and the substrate component 1 may be pressed onto the substrate 2 during reflow while the posts 101 are firmly held in place. In this way, the substrate component 1 may be surface-mounted to the substrate 2, thus obviating any need for through-holes in the substrate 2. The posts 101 may be of plastic, metal or other conductive material.

FIG. 4 depicts an alternative example substrate face 1a of the substrate component 1 of the strain relief device 14, disposed for attaching to the substrate 2 using holes formed in the substrate, according to the invention. FIG. 5 is a cross section of an example post 11 shown on the example substrate face 1a of FIG. 4, according to the invention. The substrate component 1 may include posts 11 extending perpendicular from the face in a direction opposite the direction indicated by the arrow z. The posts 11 may include a pin 11b and a shoulder 11a. When mounting the connector component 1, holes 29 are formed in the substrate 2 in positions corresponding to the location of the pins 11b. The pins 11b would be inserted into the corresponding holes 29 in the substrate and could be soldered or otherwise attached to the substrate 2. The pins 11b may be circular, square or of a polygon shape. The posts 11 may be formed as part of the substrate component 1 or may otherwise be secured in indentations formed in the substrate component 1.

The shoulder 11a may abut a surface 2b of the substrate 2, while the pin 11b extends in the corresponding hole 29. The shoulder 11a may be soldered to the surface 2b of the substrate 2, and may absorb or resist forces applied on the substrate component 1 in a direction of the arrow F, shown in FIG. 5. In this way, the shoulders 1a may prevent damage to the electrical connection of the connector 5 to the substrate 2 by preventing the connector 5 from being pressed onto, that is, forced toward the substrate 2. Such a force may occur, for example, if an electrical connector is connecting an orthogonal daughter card to a horizontal motherboard.

Thus there have been described systems and methods for improved strain relief devices for electrical connectors. It is to be understood that the foregoing illustrative embodiments have been provided merely for the purpose of explanation and are in no way to be construed as limiting of the invention. For example, the strain relief devices may be used to attach substrates other than daughter cards and mother boards. Words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1. A substrate component of a strain relief device for an electrical connector, comprising:
a connector face comprising an alignment element adapted to mate with an alignment element of a connector component of the strain relief device, wherein the connector component is formed as part of or attached to a portion of the electrical connector; and
a substrate face adapted to attach the substrate component to a substrate such that the substrate component alignment element is disposed to be mated with the connector component alignment element after the substrate component is attached to the substrate.

2. The substrate component of claim 1, wherein the alignment element of the substrate component comprises a protrusion extending from the connector face and adapted for insertion into an indentation of the alignment element of the connector component.

3. The substrate component of claim 1, wherein the alignment element of the substrate component comprises an indentation in the connector face adapted for receiving a protrusion of the alignment element of the connector component.

4. The substrate component of claim 1, wherein the alignment element of the substrate component and of the connector component prevent movement of the connector component relative to the substrate component when the substrate and connector components are mated.

5. The substrate component of claim 1 further comprising:
an alignment pin receiving indentation for receiving an alignment pin, wherein the alignment pin facilitates alignment during mating of the substrate and connector components.

6. The substrate component of claim 5, wherein the alignment pin is made of a conductive material and electrically connects the substrate and connector components to facilitate discharge of static electricity.

7. The substrate component of claim 1, further comprising:
a pocket formed in the substrate face of the substrate component, the pocket comprising a post adapted to be attached to a solder ball.

8. The substrate component of claim 7, wherein the post comprises barbs that cut into the substrate component to secure the post in the substrate component.

9. The substrate component of claim 1, further comprising:
a post protruding from the substrate face comprising a pin and a shoulder, wherein the pin is adapted for insertion into a hole in the substrate, and the shoulder is adapted to abut a surface of the substrate when the substrate component is mounted on the substrate.

10. An electrical connector, comprising:
a connector component of a strain relief device, the connector component comprising an alignment element adapted to mate with an alignment element of a substrate component of the strain relief device after the substrate component is attached to a substrate.

11. The electrical connector of claim 10, wherein the alignment element of the connector component is adapted to mate with the alignment element of the substrate component when the electrical connector is electrically connected to the substrate.

12. The electrical connector of claim 10, wherein the alignment element of the connector component comprises a protrusion adapted for insertion into an indentation of the alignment element of the substrate component.

13. The electrical connector of claim 10, wherein the alignment element of the connector component comprises an indentation adapted to receive a protrusion of the alignment element of the substrate component.

14. The electrical connector of claim 10, wherein the alignment element of the substrate component and of the connector component prevent movement of the electrical connector relative to the substrate when the connector and substrate components are mated.

15. A strain relief device for an electrical connector, comprising:
a connector component defining a portion of the electrical connector and comprising an alignment element; and
a substrate component comprising a substrate face adapted to attach to a substrate and a connector face comprising an alignment element disposed to mate with the alignment element of the connector component after the substrate component is attached to the substrate.

16. The strain relief device of claim 15, wherein the alignment element of the substrate component comprises a protrusion and the alignment element of the connector component comprises an indentation, and wherein the protrusion is adapted for insertion into the indentation.

17. The strain relief device of claim 15, wherein the alignment element of the connector component comprises a protrusion and the alignment element of the substrate component comprises an indentation, and wherein the protrusion is adapted for insertion into the indentation.

18. The strain relief device of claim 15, wherein the strain relief device prevents movement of the electrical connector after it is electrically connected to the substrate when a sheer force is applied to the electrical connector.

19. The strain relief device of claim 15, further comprising:
an alignment pin received in an indentation formed in each of the substrate and connector components.

20. The strain relief device of claim 15, wherein the alignment element of the substrate component and of the connector component are press fit together.

21. The substrate component of claim 1, wherein the substrate face is adapted to be soldered to the substrate component.

22. The substrate component of claim 21, wherein the substrate face comprises a solder ball.
